(19) United States
(12) Patent Application Publication
(10) Pub. No.: US 2008/0266850 A1
(43) Pub. Date: Oct. 30, 2008

(54) Ambient Light to Reduce Power Consumption and to Increase Brightness of Backlit electronic Displays

(76) Inventor: Fawzi Adel Masri, Campbell, CA (US)

Correspondence Address: FAWZI ADEL MASRI, 126 CHERRY LANE, CAMPBELL, CA, 95008, US

(21) Appl. No.: 11/739,662

(22) Filed: Apr. 24, 2007

(51) Int. Cl. F21S 19/00

(52) U.S. Cl. 362/227

(57) ABSTRACT

A method to decrease the power consumption and increase the brightness of backlit electronic displays that require a backlight such as but not limited to LCDs used in Laptops, Monitors, PDAs and cell phones, etc. . . . . The method allow such displays to make use of ambient light such as sunlight and/or indoor/outdoor lights as an aid or even a replacement to the integrated light source in the display itself.

### BACKGROUND OF THE INVENTION

The present invention is in the technical field of Backlit Electronic Displays

More particularly, the present invention is in the technical field of Power Consumption and display brightness

### BRIEF SUMMARY OF THE INVENTION

The present invention is a method to reduce power consumption and increase the brightness of backlit electronic displays using the ambient light.

### BRIEF DESCRIPTION OF THE SEVERAL VIEWS OF THE DRAWING

FIG. 1 is a side view of a typical Display. Ambient light is prohibited form entry and is not utilized

FIG. 2 is a side view of couple of example 1 of using ambient light per the present invention.

FIG. 3 is a side view of couple of example 2 of using ambient light per the present invention.

FIG. 3 is a front view of a contrast enhancement per the present invention.

### DETAILED DESCRIPTION OF THE INVENTION

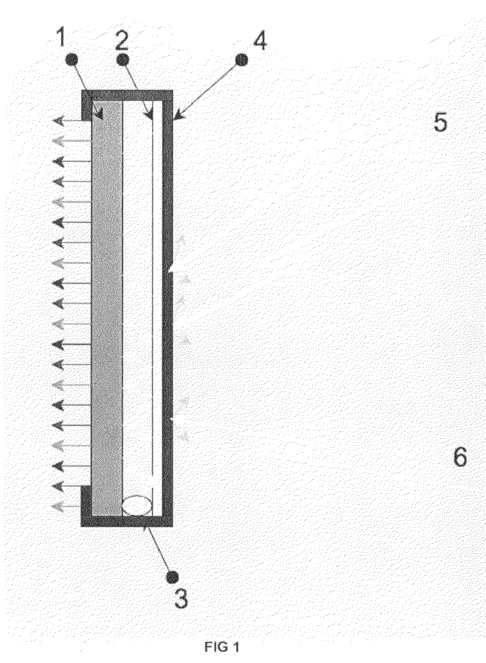

As a precursor to the present invention, FIG. 1 depicts a typical layout of an electronic Backlit display such as, but not limited to, LCD (liquid crystal Display) displays found in laptops, PDA and other electronic devices. These displays are typically made of 3 major components, the front screen 1, a translucent reflector panel 2, and an integrated light source 3. These 3 components are usually sandwiched together in a tight seal casing 4, to prevent external light from interfering with the light emitted by the integrated light source 3. Only the front screen 1 is visible for user to view what is displayed.

In such designs the ambient light surrounding the display such as sunlight 5 or indoor lights 6 are not utilized. They are only monitored to modify (increase or decrease) the light intensity for user comfort. But such minor modifications are not useful in extremely bright area, nor are designed for the purpose of reducing power consumption.

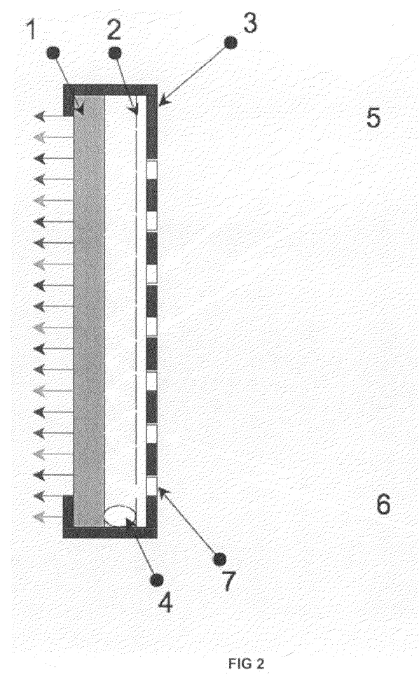

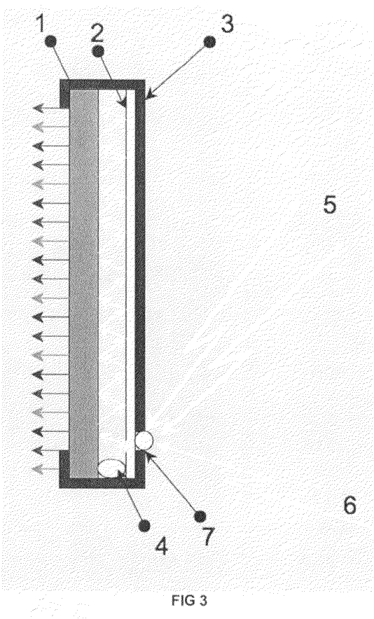

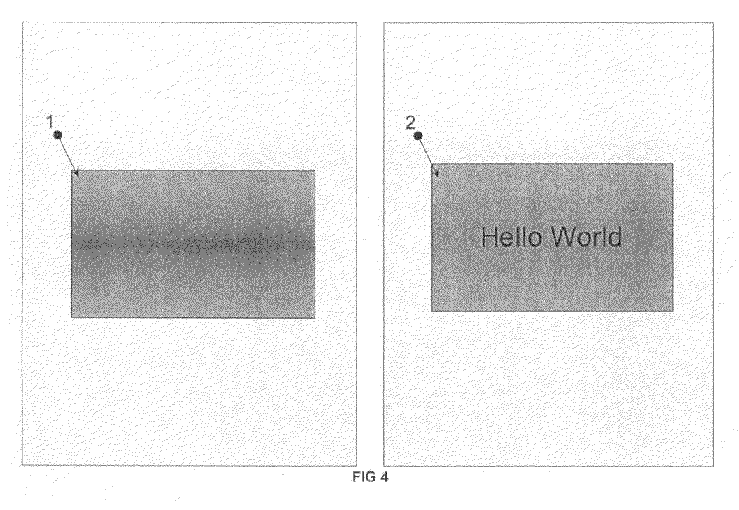

Referring now to the invention in more detail In FIG. 2 and FIG. 3, the same display from FIG. 1, is depicted, only this time the ambient light such as sunlight or indoor/outdoor bright lights are allowed to enter thru multiple holes 7 as in FIG. 2 or thru a concentrating lens/prism 7 as in FIG. 3. One can use different types and mechanisms to control when and the amount of ambient light to enter the back panel.

In further detail, still referring to the invention of FIG. 4 depicts a comparison between two backlit displays in bright light such as sunlight. Without implementing the present invention 1, the integrated backlight cannot light the screen strong enough and the display is not clear. In 2 the display implements the present invention and the display is clearer due to the utilization of the sunlight to brighten the display.

### Advantages:

In the presence of a well-lit room or in a sunny outdoors, the advantages of the present invention include:

1—The integrated backlight can be dimmed or completely turned off, thus conserving power, which is an important factor, irrespective of whether the Power source is a battery or an electric outlet.

2—In extremely bright areas, such as direct sunlight, the integrated light cannot illuminate the display strong enough to overcome the surrounding ambient light. Allowing the same ambient light to brighten the display will compensate for the weakness of the backlight to illuminate the whole screen.

In both of the cases above the ambient source of strong light is always placed behind the display.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. The present invention will allow a backlit display to reduce power consumption in well-lit areas such as sunny areas or rooms with extremely bright external source of light.

2. The present invention will brighten backlit displays and make them more readable in well-lit areas such as sunny areas or rooms with extremely bright external source of light.
